(19) United States
(12) Patent Application Publication
(10) Pub. No.: US 2026/0362040 A1
(43) Pub. Date: Nov. 12, 2026

(54) Integrated Audio Device for Powered Sofa

(71) Applicant: MotoMotion China Corporation, Changzhou (CN)

(72) Inventors: Yuhai Wu, Changzhou (CN); Chen Chen, Changzhou (CN); Wuqing Pan, Changzhou (CN)

(73) Assignee: MotoMotion China Corporation, Changzhou (CN)

(21) Appl. No.: 19/200,753

(22) Filed: May 7, 2025

(51) Int. Cl. H04R 1/02

(52) U.S. Cl. CPC H04R 1/025

(57) ABSTRACT

An integrated audio device for powered sofa is provided, comprising: a power amplifier; and small speakers, low-frequency vibrators, and wiring hubs disposed in each seat of the powered sofa; where the small speakers have a volume smaller than that of full-range speakers; the power amplifier is connected to one of the wiring hubs, each of the wiring hubs is connected to the small speakers and low-frequency vibrators respectively, and the wiring hubs provided in seats are interconnected via cables. Through this application, installation convenience and efficiency for users are improved, thus improving the user experience.

### TECHNICAL FIELD

The present application relates to the technical field of powered chairs or sofas, and particularly to an integrated audio device for powered sofa.

### BACKGROUND

Current powered chairs or sofas are increasingly multifunctional, enabling precise adjustments of leg rests, backrests, and headrests via motors. Additionally, audio components such as power amplifiers, subwoofers, full-range speakers, and small speakers (full-range speakers are large in size and require enough space, while small speakers are compact in size and suitable for tight spaces) are integrated. However, subwoofers and full-range speakers can't share the same channel due to the different power demands. What's more, the volume of each speaker may be decreased if the full-range speakers use the same channel, which is to be connected in parallel.

With the increasing demands for comfort and experience, low-frequency vibrators are also integrated into the audio system, which require dedicated channels with separate positive and negative wires, increasing demands for channels and thus increasing wiring complexity.

For multi-seat powered sofas, multiple full-range speakers, small speakers, low-frequency vibrators and subwoofers are mounted on several seats of the sofa. The seats are to be packaged separately during transportation. The disassembled packaging necessitates user reassembly and reconnection of audio components, leading to potential errors, mismatched connectors, and functional failures, causing inconvenience to users.

### SUMMARY

The present disclosure provides an integrated audio device for powered sofa to enhance installation efficiency and user experience.

To achieve above objectives, some embodiments are provided below.

In one aspect, an integrated audio device for powered sofa is provided, including:
a power amplifier; and small speakers, low-frequency vibrators, and wiring hubs disposed in each seat of the powered sofa; the small speakers have a volume smaller than that of full-range speakers;
the power amplifier is connected to one of the wiring hubs, each of the wiring hubs is connected to the small speakers and low-frequency vibrators respectively, and the wiring hubs provided in the each seat are interconnected via cables.

Optionally, the power amplifier is provided in any one seat and connected to each of the wiring hubs of the same seat.

Optionally, the integrated audio device further includes full-range speakers connected to the wiring hubs.

Optionally, the integrated audio device further includes subwoofers provided in seats, each of the subwoofers is connected to each of the wiring hubs of the same seat.

Optionally, the subwoofers are provided at one or more positions inside armrests or seat cavities; the full-range speakers are provided at one or more positions behind seat backrests or within armrests; the small speakers are provided at one or more positions inside headrests or backrest; the low-frequency vibrators are provided at one or more positions inside seat cushions or backrest.

Optionally, the integrated audio device further includes a console arranged between two adjacent seats, the console is internally provided with a power amplifier and a wiring hub connected to each other.

Optionally, the integrated audio device further includes full-range speakers provided in the console and seats, where the full-range speakers provided in the console is connected to the power amplifier, and the full-range speakers provided in the seats are connected to their respective wiring hubs.

Optionally, the integrated audio device further includes a subwoofer provided within the console and connected to the power amplifier.

Optionally, the full-range speakers have a frequency range of 120 Hz to 20 kHz or 170 Hz to 20 kHz.

Optionally, the subwoofers have a frequency range of 60 Hz to 1000 Hz or 75 Hz to 1000 Hz.

Based on the specific embodiments provided in this application, the following technical effects are achieved:

This application provides an integrated audio system for powered sofas. By connecting the power amplifier, small speakers, and low-frequency vibrators through a wiring hub, all wiring and connectors are internally housed within the wiring hub, eliminating the need for users to manually connect audio components. This effectively resolves issues such as connection errors, miswirings, or omissions during assembly. Additionally, the wiring hubs in each seat are interconnected via standardized cables, enabling efficient linking of multiple powered sofa units. This design streamlines the assembly process, enhances installation convenience for users, and ultimately improves the user experience.

### BRIEF DESCRIPTION OF THE DRAWINGS

To provide a clearer explanation of the technical solutions in the embodiments of this application or related technologies, the accompanying drawings required for the embodiments will be briefly introduced below. Evidently, the drawings described herein are only some embodiments of this application. For those skilled in the art, other drawings may be derived from these illustrations without creative effort.

FIG. 1 shows a schematic view of an integrated audio system for powered sofa in accordance with some embodiments of the present disclosure.

FIG. 2 shows a schematic view of the integrated audio system for powered sofa in accordance with some embodiments of the present disclosure.

FIG. 3 shows a structural view of both ends of the connecting cable in accordance with some embodiments of the present disclosure.

FIG. 4 shows a schematic view of the internal structure of the wiring hub in accordance with some embodiments of the present disclosure.

FIG. 5 shows a schematic view of the installation layout for the integrated audio system of the powered sofa in accordance with some embodiments of the present disclosure.

FIG. 6 shows a schematic view of the installation layout for the integrated audio system of the powered sofa in accordance with some embodiments of the present disclosure.

FIG. 7 shows a structural schematic view of the powered sofa in accordance with some embodiments of the present disclosure.

Reference Numerals: 1. Full-range speaker, 2. Bass speaker, 3. Wiring hub, 31. First interface, 32. Second interface, 33. Third interface, 4. Power amplifier, 5. Low-frequency vibrator, 6. Small speaker, 7. Seat, 71. First Seat, 711. Armrest, 712. Headrest, 713. Backrest, 714. Seat portion, 72. Second Seat, 73. Third Seat, 8. Connecting cable, 9. Console.

### DETAILED DESCRIPTION OF THE EMBODIMENTS

The embodiments of this application will be described in detail below with reference to the accompanying drawings. The technical solutions in these embodiments are presented clearly and comprehensively, though it is evident that the described examples represent only a subset of the application's embodiments, not an exhaustive list. All other embodiments derived by those of ordinary skill in the art based on the content of this application, without creative effort, shall fall within the scope of protection claimed by this application.

To further clarify the objectives, features, and advantages of this application, the following provides a detailed explanation in conjunction with the accompanying drawings and specific implementations.

### Embodiments

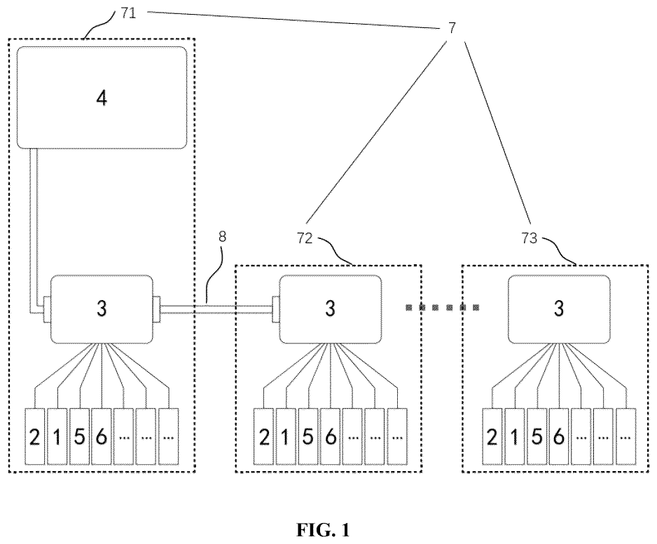

As shown in FIG. 1, an integrated audio device for a power sofa includes a power amplifier 4, small speakers 6, low-frequency vibrators 5, and wiring hubs 3 disposed in each seat of the sofa. Small speakers 6 are smaller than full-range speakers 1 in size and mounted more flexibly.

The power amplifier 4 is connected to any one of the wiring hubs 3. Each wiring hub 3 is also connected to a small speaker 6 and a low-frequency vibrator 5. The wiring hubs 3 in each seat are interconnected via connecting cables 8. The small speakers 6 and low-frequency vibrators 5 are connected to the second interface 32 of the wiring hub 3. The wiring hubs 3 in each seat are connected through connecting cables 8. For example: the third interface 33 of the wiring hub 3 in the first seat 71 is connected to the first interface 31 of the second seat 72.

In this embodiment, the power amplifier 4 is installed in the leftmost seat and connected to the wiring hub 3 within the same seat 7. As shown in FIG. 1 and FIG. 4, the power amplifier 4 is connected to the first interface 31 of the wiring hub 3.

In this embodiment, the integrated audio system further includes: a full-range speaker 1, which is connected to the second interface 32 of the wiring hub 3. The frequency range of the full-range speaker 1 spans 120 Hz-20 kHz or 170 Hz-20 kHz.

In this embodiment, the integrated audio system also includes a bass speaker 2 installed in the seat 7, which is connected to the second interface 32 of the wiring hub 3 in the same seat. The bass speaker 2 has a frequency range of 60 Hz-1000 Hz or 75 Hz-1000 Hz.

Specifically, the bass speaker 2 is installed in one or multiple locations within the armrest 711 and/or the internal cavity of the seat 7 (i.e., the seat portion 714). The full-range speaker 1 is installed in one or multiple locations within the backrest 713 and/or armrest 711 of the seat 7. The small speaker 6 is installed in one or multiple locations within the headrest 712 and/or the backrest of the seat 7. The low-frequency vibrator 5 is installed in one or multiple locations within the seat cushion and/or backrest of the seat 7.

In this embodiment, the first interface 31 and third interface 33 of the wiring hub 3 are of model HX3002-20WA, while the second interface 32 is of model HX3002-22WA.

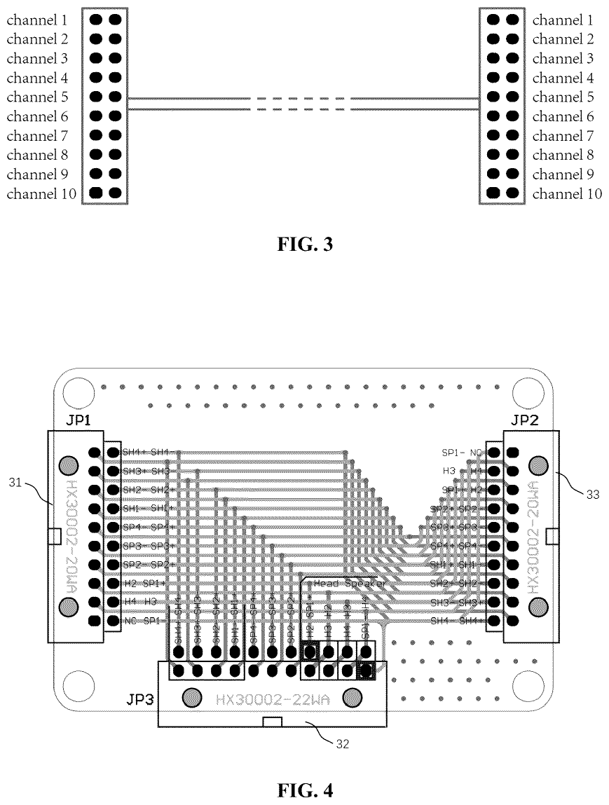

As shown in FIG. 1, the power amplifier 4 is located in the leftmost seat. As shown in FIG. 3, the connecting cable 8 extending from the power amplifier 4 contains multiple channels (Channels 1-10; the number of channels can be adjusted as needed). Each channel's voltage is configured according to the power requirements of the audio components connected thereon. All the small speakers 6 across seats 7 share one channel, while all the full-range speakers 1, all the low-frequency vibrators 5, and all the bass speaker 2 across the seats occupy individual channels. Each seat contains an additional wiring hub 3 (in the seat portion 714) with channels matching the connecting cable 8. For example, as shown in FIG. 1: In the first seat 71, the small speaker 6 is connected to Channel 1; the full-range speaker 1 is connected to Channel 2; the low-frequency vibrator 5 is connected to Channel 3; the bass speaker 2 is connected to Channel 4. In the second seat 72, the small speaker 6 is connected to Channel 1; the full-range speaker 1 is connected to Channel 5; the low-frequency vibrator 5 is connected to Channel 6; the bass speaker 2 is connected to Channel 7. The third seat 73 and the seat thereafter follow the same pattern, with connecting cables 8 connecting adjacent seats.

Each connecting cable 8 connects the wiring hub 3 of one seat to that of an adjacent seat, with independent, non-overlapping channels. Users can freely combine seats (excluding the leftmost seat containing the power amplifier 4) without affecting channel assignments. Omitting seats except the seat having the power amplifier 4 only leaves corresponding channels unused, while removing specific speakers/vibrators in a seat similarly vacates their dedicated channels without disrupting other components.

This design also simplifies assembly. As multi-seat powered sofas require disassembled shipping, all the audio components (wiring hub 3, speakers, and vibrators) are pre-installed inside each seat portion 714 and the speakers and vibrators can be pre-connected to respective wiring hubs 3 during production. Consumers need only connect adjacent wiring hubs 3 with standardized cables 8 during assembly—no additional audio wiring is required. All cables and interfaces are universally compatible, eliminating installation errors.

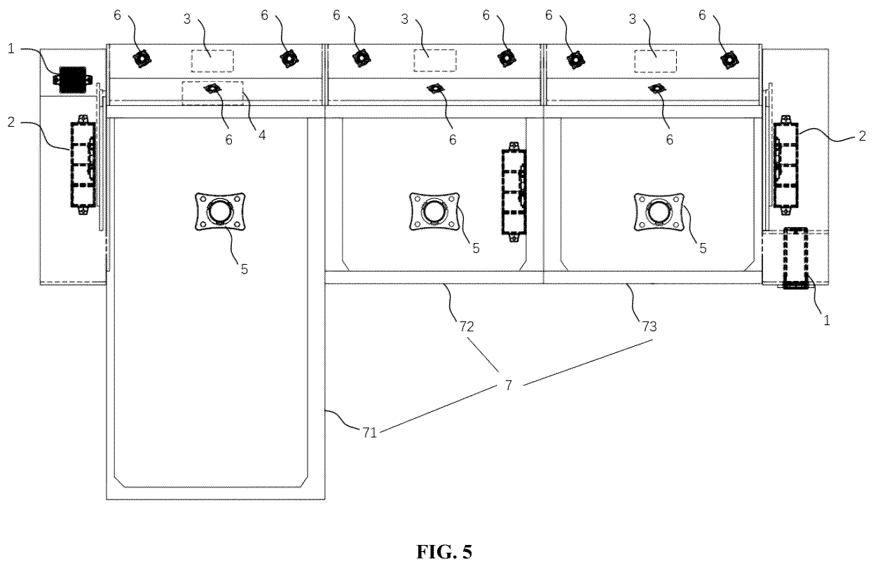

To accommodate varying power demands, series/parallel circuits are implemented in either the power amplifier 4 or wiring hub 3. For instance, in the powered sofa configured with four seats (FIG. 5 shows a three-seat example), low-frequency vibrators 5 are disposed in each seat and use a two-series-two-parallel configuration in the power amplifier 4 due to their high power. The vibrator in each seat has a dedicated channel (as shown by the cable 8 in FIG. 3). Each pair of positive and negative wires makes a channel. Removing a seat leaves its channel unused. If one vibrator is omitted, reduced resistance increases current in its series group, increasing the power and thus vibration intensity in remaining units without damage. Entire series groups can be omitted without affecting parallel groups.

Small speakers 6 (9 total across three seats, with 3 in each seat) are internally paralleled within each seat and then connected to the respective channel on the wiring hub. These groups are then series-connected via the circuit board of the wiring hub (FIG. 4). The third interface 33 of the wiring hub 3 is preconfigured with four terminals. Specifically, the third interface 33 corresponds to four terminals labeled SP1+-H2-H3-H4-SP2−, where each terminal corresponds to one positive wire and one negative wire. The terminals H2, H3, and H4 each lack one wire. The series circuit is completed using the H2, H3, and H4 on the channels on the wiring hub 3 where the connecting cable 8 is attached. In this embodiment, the three sets of small speakers 6 across three seats are connected to three of these terminals, leaving the fourth terminal vacant. Each individual full-range speaker 1 uses a dedicated channel. If a specific audio component requires parallel connections, the component across different seats can be connected to the same channel.

As shown in FIG. 4, the interface JP1 corresponds to the first interface 31 of the wiring hub 3, the interface JP2 corresponds to the third interface 33, and the interface JP3 corresponds to the second interface 32. In FIG. 1, the first interface 31 of the wiring hub 3 is connected to the power amplifier 4 in the first seat 71, while the third interface 33 is connected to the first interface 31 of the wiring hub 3 in the second seat 72. The second interface 32 is connected to the bass speaker 2, full-range speaker 1, low-frequency vibrator 5, and small speaker 6.

The power amplifier 4 can also be installed in seats other than the leftmost or rightmost positions. In such cases, the bass speaker 2, full-range speaker 1, low-frequency vibrator 5, and small speaker 6 in that seat are directly connected to the power amplifier 4, leaving the second interface 32 of the wiring hub 3 vacant for connecting the power amplifier 4. The first interface 31 and third interface 33 of the wiring hub 3 in this seat are then connected to the wiring hubs 3 of adjacent seats on either side.

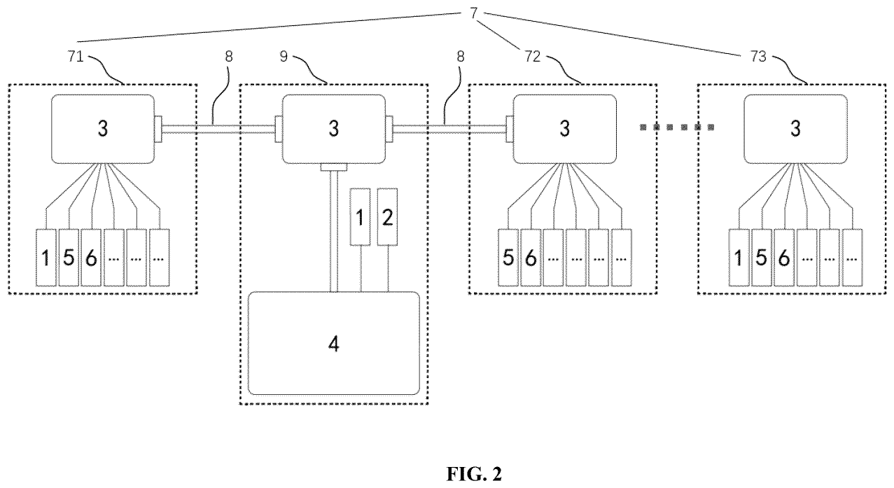

In addition to the components described in the above embodiments, as shown in FIG. 2, in some other embodiments of the present disclosure, the integrated audio device for powered sofa further includes a console 9 positioned between two seats. The console 9 internally houses a power amplifier 4 and a wiring hub 3, with the power amplifier 4 connected to the wiring hub 3 inside the console 9.

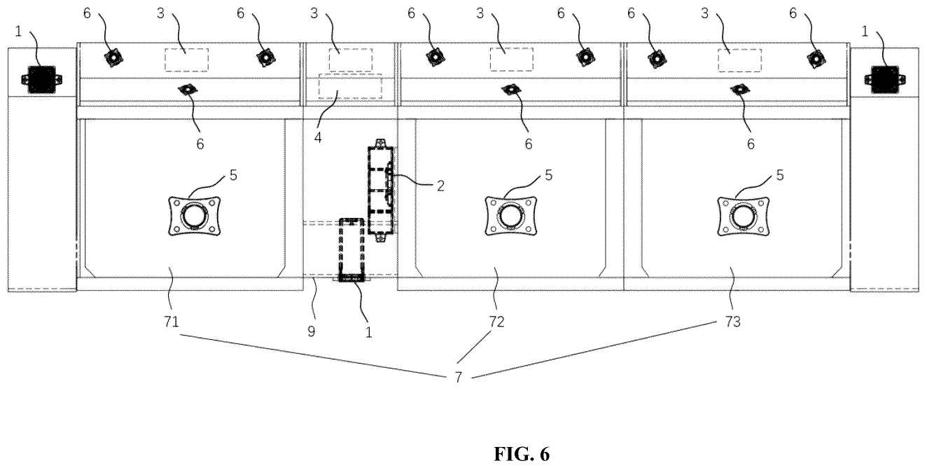

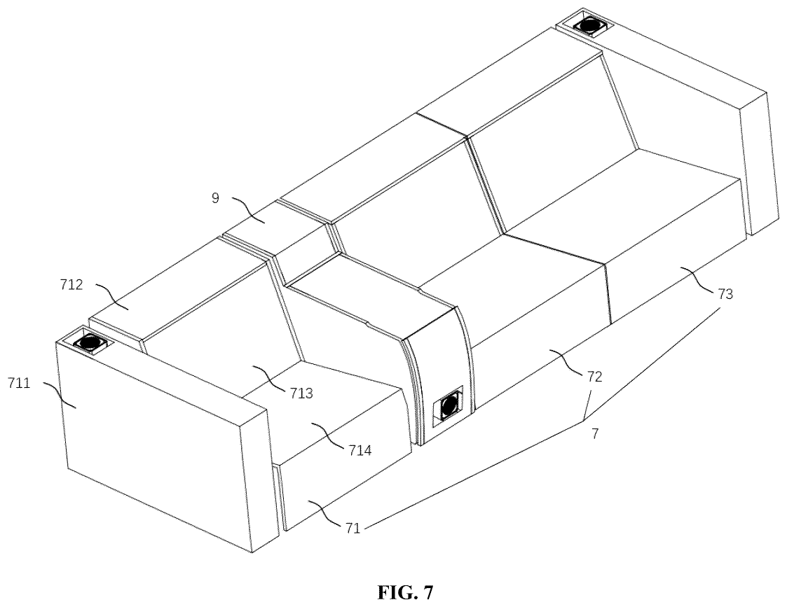

As shown in FIG. 2, FIG. 6, and FIG. 7, the integrated audio system also includes: full-range speakers 1 installed in both the console 9 and the seats 7. The full-range speaker 1 in the console 9 is connected to the power amplifier 4, while the full-range speakers 1 in the seats are connected to the wiring hub 3 within their respective seats. In the example shown in FIG. 2, since the console 9 already contains a full-range speaker 1, the seat 7 adjacent to the right side of the console 9 does not include a full-range speaker. However, a full-range speaker 1 can still be installed in the seat if requested by the customer.

The integrated audio system additionally includes a bass speaker 2 installed inside the console 9, which is connected to the power amplifier 4.

The power amplifier 4 is connected to the second interface 32 of the wiring hub 3 in the console 9. The third interface 33 of the wiring hub 3 in the first seat 71 is connected via a connecting cable 8 to the first interface 31 of the wiring hub 3 in the console 9. Similarly, the third interface 33 of the wiring hub 3 in the console 9 is connected via a connecting cable 8 to the first interface 31 of the wiring hub 3 in the second seat 72. This connection pattern continues sequentially for the third seat 73 and seats to the right. In this embodiment, only one bass speaker 2 is installed and directly connected to the power amplifier 4. The power amplifier 4 is also directly connected to one full-range speaker 1, eliminating the need for a full-range speaker 1 in the second seat 72. This configuration ensures that the audio components in the console 9 do not occupy connecting cables 8 or channels in the wiring hubs 3.

The beneficial effects of the integrated audio system for powered sofas provided in this application are as follows:
(1) By integrating audio components (power amplifier, bass speaker, full-range speaker, small speaker, low-frequency vibrator, etc.) and their connection/control logic, the assembly steps for the powered sofa are simplified, improving installation efficiency. This enhances user convenience during setup and enhances the overall user experience.
(2) Via the wiring hub design, connections are streamlined. A single connecting cable can connect audio components across multiple seats, with pre-configured dedicated channels corresponding to the cable.
(3) Seats can be freely arranged and flexibly combined in any quantity. Simply connecting the wiring hubs between seats via cables simplifies configuration, making seat combinations more user-friendly.

The technical features of the above embodiments can be combined in any manner. For brevity, not all possible combinations are described here. However, any combination of these technical features is considered within the scope of this specification.

This application uses specific examples to explain the principles and implementations of this application. The descriptions of the embodiments are intended to aid understanding of the method and core concepts of the application. Additionally, those skilled in the art may adapt the ideas presented here to modify specific implementations and applications. Therefore, the content of this specification should not be construed as limiting the scope of the application.

What is claimed is:

1. An integrated audio device for powered sofa, comprising:
a power amplifier; and
small speakers, low-frequency vibrators, and wiring hubs disposed in each seat of the powered sofa;
wherein the small speakers have a volume smaller than that of full-range speakers;
the power amplifier is connected to one of the wiring hubs, each of the wiring hubs is connected to the small speakers and low-frequency vibrators respectively, and the wiring hubs provided in the each seat are interconnected via cables.

2. The integrated audio device according to claim 1, wherein the power amplifier is provided in any one seat and connected to each of the wiring hubs of the same seat.

3. The integrated audio device according to claim 1, wherein further comprising full-range speakers connected to the wiring hubs.

4. The integrated audio device according to claim 3, wherein further comprising subwoofers provided in seats, each of the subwoofers is connected to each of the wiring hubs of the same seat.

5. The integrated audio device according to claim 4, wherein:
the subwoofers are provided at one or more positions inside armrests or seat cavities;
the full-range speakers are provided at one or more positions behind seat backrests or within armrests;
the small speakers are provided at one or more positions inside headrests or backrest;
the low-frequency vibrators are provided at one or more positions inside seat cushions or backrest.

6. The integrated audio device according to claim 1, wherein further comprising a console arranged between two adjacent seats, the console is internally provided with a power amplifier and a wiring hub connected to each other.

7. The integrated audio device according to claim 6, wherein further comprising full-range speakers provided in the console and seats, wherein the full-range speakers provided in the console is connected to the power amplifier, and the full-range speakers provided in the seats are connected to their respective wiring hubs.

8. The integrated audio device according to claim 7, wherein further comprising a subwoofer provided within the console, and connected to the power amplifier.

9. The integrated audio device according to claim 3, wherein the full-range speakers have a frequency range of 120 Hz to 20 kHz or 170 Hz to 20 kHz.

10. The integrated audio device according to claim 4, wherein the subwoofers have a frequency range of 60 Hz to 1000 Hz, or 75 Hz to 1000 Hz.
